(19) United States
(12) Patent Application Publication
(10) Pub. No.: US 2016/0376979 A1
(43) Pub. Date: Dec. 29, 2016

(54) Stratified Scavenging Two-Stroke Internal Combustion Engine, Air Cleaner Of The Same, And Intake Method

(71) Applicant: YAMABIKO CORPORATION, Tokyo (JP)

(72) Inventors: Hisato OSAWA, Tokyo (JP); Takahiro YAMAZAKI, Tokyo (JP); Hidekazu TSUNODA, Tokyo (JP); Yuuta KOBAYASHI, Tokyo (JP)

(73) Assignee: YAMABIKO CORPORATION, Tokyo (JP)

(21) Appl. No.: 15/189,013

(22) Filed: Jun. 22, 2016

(30) Foreign Application Priority Data
Jun. 24, 2015 (JP) 2015-127121

(51) Int. Cl. F02B 17/00; F02M 35/10; F02M 35/024; F02B 75/02

(52) U.S. Cl. CPC F02B 17/00; F02B 75/02; F02M 35/10078; F02M 35/1019; F02M 35/10196; F02M 35/02433; F02B 2075/025

(57) ABSTRACT

An amplitude of a pressure fluctuation in a vicinity of a main nozzle of a carburetor (32) is decreased. An air cleaner (30) has a first inlet (60) that feeds air to an intake system air channel, and a second inlet (62) that feeds air to an intake system air-fuel mixture channel. A channel formation member (70) is attached to the second inlet (62). A channel length (L2) of an extension channel (72) formed by the channel formation member (70) is 110 mm or more.

### BACKGROUND OF THE INVENTION

The present application claims a priority from Japanese Patent Application No. 2015-127121, filed Jun. 24, 2015, which is incorporated herein by reference.

The present invention relates to a stratified scavenging two-stroke internal combustion engine, an air cleaner of the same, and an intake method.

Two-stroke internal combustion engines are used in power sources of portable working machines such as a brush cutter, a chain saw and a power blower.

U.S. Pat. No. 7,494,113 B2 discloses a stratified scavenging two-stroke internal combustion engine. A stratified scavenging engine has a feature of introducing air containing no air-fuel mixture, that is, fresh air into a combustion chamber before introducing the air-fuel mixture in a crank chamber into the combustion chamber, in a scavenging stroke. The fresh air which is introduced into the combustion chamber at an initial stage of the scavenging stroke is also called “leading air”.

The engine disclosed in U.S. Pat. No. 7,494,113 B2 has an intake system having two channels. The first channel is an “air channel”. The second channel is an “air-fuel mixture channel”. Through the air channel, fresh air, namely, the leading air is fed to the engine body. Air-fuel mixture is fed to the crank chamber of an engine body through the air-fuel mixture channel.

The intake system disclosed in U.S. Pat. No. 7,494,113 B2 is configured by an air cleaner, a carburetor, and an intake member connecting the carburetor and the engine body. The intake member has a first partition wall extending continuously in a longitudinal direction. In the intake member, the air channel and the air-fuel mixture channel which are independent from each other are formed by the first partition wall.

The carburetor disclosed in U.S. Pat. No. 7,494,113 B2 has a throttle valve and a choke valve. The throttle valve and the choke valve are both configured by butterfly valves. During a full throttle operation, the throttle valve and the choke valve are in fully opened states.

The carburetor disclosed in U.S. Pat. No. 7,494,113 B2 has a second partition wall that divides an internal gas channel into two. When the throttle valve and the choke valve are in the fully opened states, an internal channel of the carburetor is partitioned into an air channel and an air-fuel mixture channel by the two valves and the second partition wall.

Thereby, at the time of working in a full throttle operation state, the air purified by the air cleaner is fed to the engine body through the air channel, and is fed to the crank chamber through the air-fuel mixture channel. The carburetor has a fuel nozzle in the air-fuel mixture channel thereof. Fuel is taken out from the fuel nozzle by the air passing through the air-fuel mixture channel in the carburetor, and in the air-fuel mixture channel in the carburetor, the air-fuel mixture in which the fuel and the air are mixed with each other is generated.

U.S. Pat. No. 7,494,113 B2 discloses two kinds of carburetors. A first type carburetor and a second type carburetor have different partition walls. The partition wall of the first type carburetor has a shape that separates the gas channel in the carburetor into two channels together with the throttle valve in the fully opened state and the choke valve in the fully opened state (FIG. 3 in U.S. Pat. No. 7,494,113 B2). That is, in an operation state at a high speed revolution, the air channel and the air-fuel mixture channel which are independent from each other are formed in the intake system including the first type carburetor.

The partition wall of the second type carburetor has a window (FIG. 4 in U.S. Pat. No. 7,494,113 B2) formed by omitting a part of the partition wall of the above described first type carburetor. The air channel and the air-fuel mixture channel of the second type carburetor communicate with each other through the window of the partition wall. That is, the intake system including the second type carburetor has the window which communicates with the air channel and the air-fuel mixture channel in the carburetor. The air channel and the air-fuel mixture channel of the intake system extend from the air cleaner to the engine body. In a full throttle operation state, the intake system including the second type carburetor is in a state where the air channel and the air-fuel mixture channel partially communicate with each other through the window, namely, an opening portion.

U.S. 2014/0261277 A1 discloses an intake device of a stratified scavenging two-stroke internal combustion engine. An embodiment of U.S. 2014/0261277 A1 adopts the above described first type carburetor. That is, in the intake device disclosed in U.S. 2014/0261277 A1, at the time of full throttle, an engine intake system is in a state where an air channel and an air-fuel mixture channel of the engine intake system are separated by a throttle valve in a fully opened state, a choke valve in a fully opened state and the partition wall without the above described opening portion.

The intake device disclosed in U.S. 2014/0261277 A1 has an air cleaner, and an intermediate member that is interposed between the air cleaner and the carburetor. The air cleaner has two inlets that receive purified air (clean air) that is purified by a cleaner element and feed the purified air to the carburetor. The first inlet feeds the air to the air channel. The second inlet feeds the air to the air-fuel mixture channel.

For the purpose of tuning pressure waves of the first and the second inlets with each other, the above described intermediate member is interposed between the air cleaner and the carburetor. The intermediate member has an object to extend the air channel in which the purified air passes. By the intermediate member, both the intake system air channel and the intake system air-fuel mixture channel are substantially extended at the upstream side of the carburetor. The intermediate member disclosed in U.S. 2014/0261277 A1 has an air channel and air-fuel mixture channel which are divided by the partition wall, and the air channel and the air-fuel mixture channel both have shapes folded into hairpin shapes.

Japanese Patent Laid-Open No. 2008-261296 discloses an air cleaner that is applied to a stratified scavenging two-stroke internal combustion engine. The air cleaner has a first inlet that feeds purified air (clean air) which is purified in a cleaner element to an air channel of a carburetor, and a second inlet that feeds the purified air to an air-fuel mixture channel of the carburetor, and an additional air guide member is attached to the second inlet. The air guide member has an L-shape in side view, and a tip end portion of the air guide member is located to face the first inlet.

According to the air cleaner disclosed in Japanese Patent Laid-Open No. 2008-261296, blowback of the air-fuel mixture which flows out of the second inlet is received by a bent portion of the L-shaped air guide member. Thereby, fuel contained in the blowback air-fuel mixture can be prevented from flowing out of the entrance opening of the air guide member and diffusing to the inside of the air cleaner.

### SUMMARY OF THE INVENTION

The inventors of the present application aimed at further improvement of the air cleaner disclosed in Japanese Patent Laid-Open No. 2008-261296 including the aforementioned L-shaped air guide member, and has reached the present invention while conducting a study on the length dimension of the aforementioned air guide member.

The air guide member disclosed in Japanese Patent Laid-Open No. 2008-261296 will be referred to as an “air-fuel mixture channel extension member”, and a channel that is formed by the air guide member will be referred to as an “extension air-fuel mixture channel”. A pressure fluctuation in the vicinity of the main nozzle of the carburetor was investigated by variously changing the channel length of the extension air-fuel mixture channel.

U.S. Pat. No. 7,494,113 B2 discloses the two types carburetors, as described above. The partition wall of the first type carburetor has the shape which separates the gas channel in the carburetor into two channels together with the throttle valve in the fully opened state and the choke valve in the fully opened state. That is, in the operation state at a high speed revolution, that is, in the operation state with full throttle or near full throttle, the air channel and the air-fuel mixture channel which are independent from each other are formed in the intake system including the first type carburetor. In the case of the stratified scavenging two-stroke engine including the first type carburetor, an amplitude of the pressure fluctuation in the vicinity of the main nozzle was not changed so much even when the channel length of the extension air-fuel mixture channel was changed.

The second type carburetor disclosed in U.S. Pat. No. 7,494,113 B2 has the window formed by omitting a part of the partition wall. In the intake system including the second type carburetor, the air channel and the air-fuel mixture channel are in a state communicating with each other through the window of the above described partition wall, that is, through the opening portion. It has been found that in the case of this kind of engine, when the channel length of the extension air-fuel mixture channel is extended, the amplitude of the pressure fluctuation in the vicinity of the main nozzle does not change so much up to a certain length, but when the channel length becomes the certain length or more, the amplitude of the pressure fluctuation in the vicinity of the main nozzle becomes small. The applicant of the present application proposes the invention based on the finding.

An object of the present invention is to provide a stratified scavenging two-stroke internal combustion engine, an air cleaner of the same, and an intake method, which decreases an amplitude of a pressure fluctuation in a vicinity of a main nozzle of a carburetor, and thereby can enhance stability of an operation state (stability of output) of the engine.

The present invention is applied to a stratified scavenging two-stroke internal combustion engine in which an air channel and an air-fuel mixture channel of an intake system including a carburetor, and these channels communicate with each other through the above described opening portion. A typical example thereof is the engine including the intake system including the second type carburetor of U.S. Pat. No. 7,494,113 B2. The above described opening portion is typically formed in the carburetor. More specifically, the carburetor is a carburetor including a partition wall including the window disclosed in FIG. 4 in U.S. Pat. No. 7,494,113 B2. In a carburetor without a partition wall between a throttle valve and a choke valve, the above described opening portion may be formed between these valves. Further, the carburetor is not limited to a butterfly type carburetor, but may be a rotary valve type carburetor.

The engine to which the present invention is applied typically has a single cylinder. As is well known, in the carburetor, an amount of fuel flowing out from a main nozzle located in a vicinity of the throttle valve is regulated by controlling an opening degree of the throttle valve.

The stratified scavenging two-stroke internal combustion engine of the present invention is favorably used as a power source of a portable working machine. A piston displacement of the two-stroke internal combustion engine loaded on a portable working machine is 20 cc to 100 cc. The present invention is suitably applied to an engine with a small piston displacement of this kind. The present invention is preferably applied to an engine with a piston displacement of 25 cc to 70 cc, more preferably to an engine with a piston displacement of 30 cc to 60 cc, and the most preferably to an engine with a piston displacement of 40 cc to 50 cc.

In the two-stroke internal combustion engine of the present invention, in an upstream side of the carburetor, a channel length of one of the intake system air channel and the intake system air-fuel mixture channel is much longer than a channel length of the other of the intake system air channel and the intake system air-fuel mixture channel. That is, when viewed in an upstream of the opening portion, one of the air channel and the air-fuel mixture is longer than the other. In other words, one of the air channel and the air-fuel mixture channel has the channel length obtained by extending the channel length of said one of the air channel or the air-fuel mixture channel with respect to the other. When viewed in an upstream of the opening portion, a difference between the channel length of one of the air channel and the air-fuel mixture channel, and the channel length of the other is referred to as an “extension channel length”. The extension channel length is 110 mm or more.

When the extension channel length is shorter than 110 mm, the amplitude of the pressure fluctuation in the vicinity of the main nozzle does not change so much as compared with the amplitude at the time of the extension channel length being zero. When the extension channel length becomes 110 mm or more, the amplitude of the pressure fluctuation in the vicinity of the main nozzle decreases. When the amplitude of the pressure fluctuation in the vicinity of the main nozzle decreases, fuel can be stably drawn out to the air-fuel mixture channel from the main nozzle.

The extension channel length is generally formed by a channel formation member. The channel formation member may be interposed between the carburetor and the air cleaner, but is typically disposed in the air cleaner. An extension air-fuel mixture channel or an extension air channel which is formed by the channel formation member may have a shape curved into a hairpin-shape, or may have a bending shape. Hereinafter, the present invention will be described in detail on the basis of experimental data.

### BRIEF DESCRIPTION OF THE DRAWINGS

FIG. 1 shows a diagram for explaining an outline of a stratified scavenging two-stroke engine of an embodiment according to the present invention;

FIG. 2 shows a diagram for explaining an internal structure of an air cleaner incorporated in the engine in FIG. 1;

FIG. 3 is a diagram for explaining an intake system of a comparative example;

FIG. 4 is a diagram for explaining a channel length of an extension air-fuel mixture channel, with a rectilinear extension air-fuel mixture channel taken as an example;

FIG. 5 shows a diagram showing a pressure fluctuation in a vicinity of a main nozzle at a time of an engine speed of 9,500 rpm in a comparative example in which an extension channel length L2 satisfies “L2=0 mm”;

FIG. 6 shows a diagram showing a pressure fluctuation in the vicinity of the main nozzle at the time of the extension channel length L2 satisfying “L2=90 mm”, and the engine speed being 9,500 rpm;

FIG. 7 shows a diagram showing a pressure fluctuation in the vicinity of the main nozzle at the time of the extension channel length L2 satisfying “L2=110 mm”, and the engine speed being 9,500 rpm;

FIG. 8 shows a diagram showing a pressure fluctuation in the vicinity of the main nozzle at the time of the extension channel length L2 satisfying “L2=120 mm”, and the engine speed being 9,500 rpm;

FIG. 9 shows a diagram showing a pressure fluctuation in the vicinity of the main nozzle at the time of the extension channel length L2 satisfying “L2=132.5 mm”, and the engine speed being 9,500 rpm;

FIG. 10 shows a diagram showing a pressure fluctuation in the vicinity of the main nozzle at the time of the extension channel length L2 satisfying “L2=172.5 mm”, and the engine speed being 9,500 rpm;

FIG. 11 shows a diagram showing a pressure fluctuation in the vicinity of the main nozzle at the time of the extension channel length L2 satisfying “L2=254 mm”, and the engine speed of 9,500 rpm;

FIG. 12 shows a diagram showing a pressure fluctuation in a vicinity of a main nozzle at the time of an engine speed being 8,000 rpm in a comparative example in which the extension channel length L2 satisfies “L2=0 mm”;

FIG. 13 shows a diagram showing a pressure fluctuation in the vicinity of the main nozzle at the time of the extension channel length L2 satisfying “L2=90 mm”, and the engine speed being 8,000 rpm;

FIG. 14 shows a diagram showing a pressure fluctuation in the vicinity of the main nozzle at the time of the extension channel length L2 satisfying “L2=132.5 mm”, and the engine speed being 8,000 rpm;

FIG. 15 shows a diagram showing a pressure fluctuation in the vicinity of the main nozzle at the time of the extension channel length L2 satisfying “L2=172.5 mm”, and the engine speed being 8,000 rpm;

FIG. 16 shows a diagram showing a pressure fluctuation in the vicinity of the main nozzle at the time of the extension channel length L2 satisfying “L2=254 mm” and the engine speed being 8,000 rpm;

FIG. 17 shows a diagram for schematically explaining a curvilinear extension air-fuel mixture channel;

FIG. 18 shows data for explaining that there is no difference in amplitude of the pressure fluctuation in the vicinity of the main nozzle whether the extension air-fuel mixture channel is in a rectilinear shape or in a curvilinear shape;

FIG. 19 shows a diagram for schematically explaining an extension air-fuel mixture channel which is bent into a hairpin-shape;

FIG. 20 is a diagram showing a pressure fluctuation in a vicinity of a main nozzle in an engine which adopts the extension air-fuel mixture channel which is bent into a hairpin-shape illustrated in FIG. 19: and

FIG. 21 shows a diagram showing an amplitude of a pressure fluctuation in a vicinity of a main nozzle at the time of providing the extension air-fuel mixture channel in a stratified scavenging two-stroke engine in which an intake system air channel and an intake system air-fuel mixture channel are separated.

### DETAILED DESCRIPTION OF THE PRESENT INVENTION

Preferred embodiments of the present invention will be described on the basis of the accompanying drawings. The embodiment disclosed hereinafter is an example of extending an intake system air-fuel mixture channel. The present invention can be also applied to an example of extending an intake system air channel, instead of extension of the intake system air-fuel mixture channel.

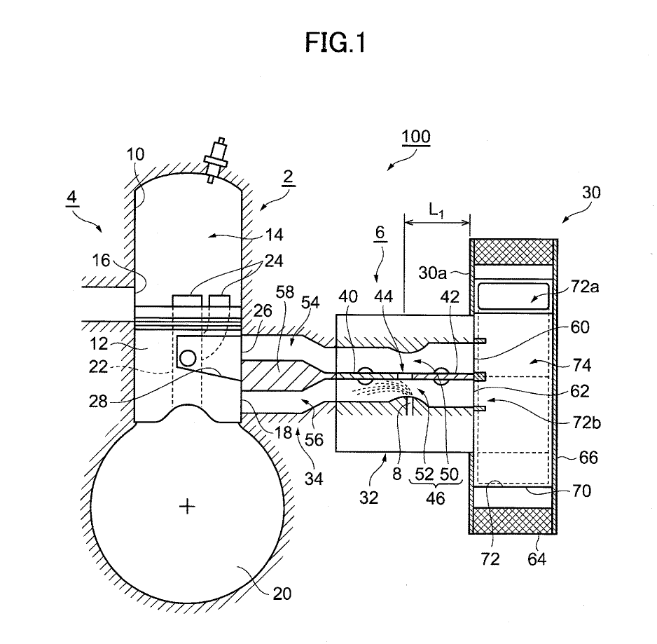

FIG. 1 shows a diagram for explaining an outline of a stratified scavenging two-stroke internal combustion engine of the preferred embodiment. Referring to FIG. 1, reference numeral 100 denotes a stratified scavenging two-stroke internal combustion engine. The engine 100 is loaded on a portable working machine such as a brush cutter and a chain saw.

As is understandable from FIG. 1, the engine 100 is a single cylinder engine, and is an air-cooled engine. The engine has a piston displacement of 40 cc to 50 cc. The engine 100 has an engine body 2, an exhaust system 4 and an intake system 6.

The engine body 2 has a piston 12 that is fitted into the cylinder 10, and a combustion chamber 14 is formed by the piston 12. The piston 12 reciprocates in the cylinder 10. Reference numeral 16 denotes an exhaust port. An exhaust system 4 is connected to the exhaust port 16. Reference numeral 18 denotes an air-fuel mixture port. The air-fuel mixture port 18 leads to a crank chamber 20 of the engine 100.

In the cylinder 10, scavenging channels 22 that connect the crank chamber 20 and the combustion chamber 14 is formed. In the scavenging channel 22, one end communicates with the crank chamber 20, and the other end communicates with the combustion chamber 14 through a scavenging port 24.

The cylinder 10 also has an air port 26. Fresh air which will be described later, that is, air containing no air-fuel mixture is fed to the air port 26. The scavenging port 24 and the air port 26 communicate with each other via a piston groove 28. That is to say, the piston 12 has the piston groove 28 on a circumferential surface thereof. The piston groove 28 is a recess formed on the circumferential surface of the piston 12, and has a function to temporarily store air.

The exhaust port 16, the air-fuel mixture port 18, the scavenging port 24 and the air port 26 are opened and closed by the piston 12. That is, the engine body 2 is of a so-called piston valve type. The communication between the piston groove 28 and the scavenging ports 24 and the communication between the piston groove 28 and the air port 26 are shut off by the operation of the piston 12. In other words, the reciprocation of the piston 12 controls communication and shut-off between the piston groove 28 and the scavenging ports 24, as well as controlling communication and shut-off between the piston groove 28 and the air port 26.

The intake system 6 is connected to the air port 26 and the air-fuel mixture port 18. The intake system 6 has an air cleaner 30, a carburetor 32 and an intake member 34. The intake member 34 is made of a flexible material (an elastic resin). The carburetor 32 is connected to the engine body 2 via the flexible intake member 34. The air cleaner 30 is fixed to an upstream end of the carburetor 32.

The carburetor 32 has a throttle valve 40 and a choke valve 42 that is located upstream of the throttle valve 40. As a modification example of the carburetor 32, the carburetor 32 may be a rotary valve type carburetor.

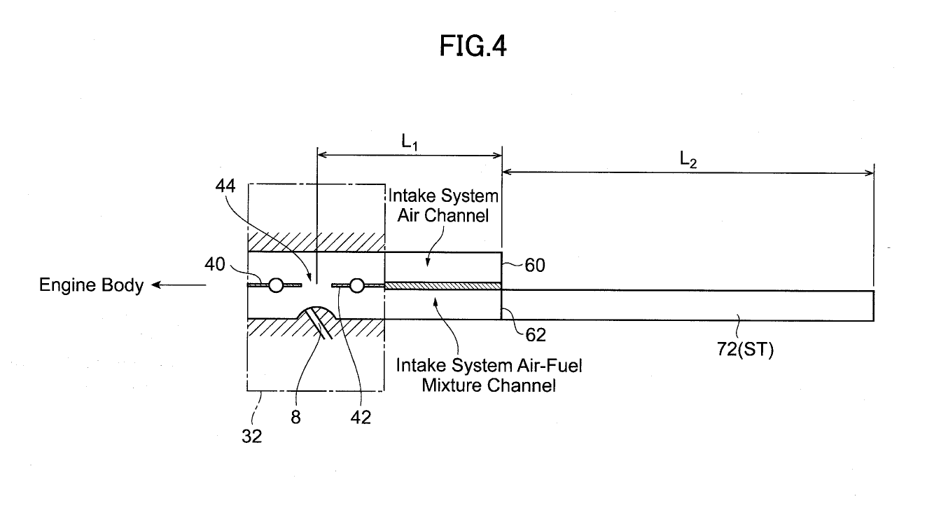

In the carburetor 32 illustrated in FIG. 1, the throttle valve 40 and the choke valve 42 are both configured by butterfly valves. The carburetor 32 has an opening portion 44 between the throttle valve 40 and the choke valve 42. The opening portion 44 is formed by cutting out a part of a first partition wall not illustrated. A specific example of the opening portion 44 is a window of the partition wall disclosed in FIG. 4 of U.S. Pat. No. 7,494,113 B2. Note that the opening portion 44 may be located between the carburetor 32 and the engine body 2.

The carburetor 32 may be a carburetor without the first partition wall described above. That is, the carburetor 32 may be a carburetor in which a space between the throttle valve 40 and the choke valve 42 are configured by an open space.

When the throttle valve 40 and the choke valve 42 are in a fully opened state, that is, when the engine 100 is in an operation state at a high speed revolution, a first air channel 50 and a first air-fuel mixture channel 52 are formed in an internal gas channel 46 in the carburetor 32 by the throttle valve 40, the choke valve 42 and the above described first partition wall.

In FIG. 1, reference numeral 8 denotes a main nozzle. At times of a partial load and a high load, fuel is drawn out from the main nozzle 8 to the first air-fuel mixture channel 52 of the carburetor 32.

The intake member 34 which is interposed between the carburetor 32 and the engine body 2 has a second partition wall 58. The intake member 34 has a second air channel 54 that is located at one side, and a second air-fuel mixture channel 56 that is located at the other side, with the second partition wall 58 sandwiched therebetween. The above described opening portion 44 may be provided in the intake member 34.

The carburetor 32 and the engine body 2 may be connected by a first member including the second air channel 54 and a second member including the second air-fuel mixture channel 56 apart from the first member, instead of the intake member 34 including the second air channel 54 and the second air-fuel mixture channel 56.

As is understandable from the aforementioned explanation, downstream of the air cleaner 30, an air channel of the intake system 6 is formed by the first air channel 50 in the carburetor 32 and the second air channel 54 of the intake member 34. Meanwhile, an air-fuel mixture channel of the intake system is formed by the first air-fuel mixture channel 52 in the carburetor 32 and the second air-fuel mixture channel 56 of the intake member 34.

The air cleaner 30 has a first inlet 60 and a second inlet 62, and the first inlet 60 and the second inlet 62 are independent from each other. Outside air is purified by a cleaner element 64 and purified air (clean air) is made. The purified air enters the intake system air channel through the first inlet 60 and enters the intake system air-fuel mixture channel through the second inlet 62.

A channel formation member 70 is connected to the second inlet 62 of the air cleaner 30, that is, the inlet leading to the intake system air-fuel mixture channel. The channel formation member 70 has an extension air-fuel mixture channel 72. The extension air-fuel mixture channel 72 has an entrance opening 72a and an exit opening 72b. A part of the air purified by the cleaner element 64 enters the extension air-fuel mixture channel 72 through the entrance opening 72a. Subsequently, the air passing through the extension air-fuel mixture channel 72 enters the second inlet 62 through the exit opening 72b.

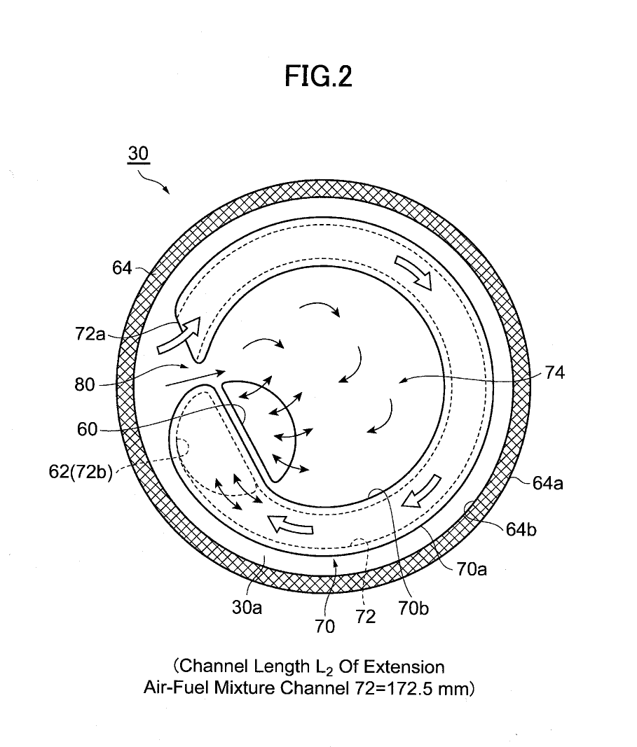

The channel formation member 70 has a shape encircling a periphery of the first inlet 60 leading to the intake system air channel. FIG. 2 shows a diagram of the air cleaner 30 in plan view.

Referring to FIG. 2, the air cleaner 30 has a circular shape in plan view, and the cleaner element 64 is disposed on a base 30a of the air cleaner 30. The cleaner element 64 has a shape of a circular ring in plan view, and an outer circumferential face 64a of the cleaner element 64 configures an outer circumferential face of the air cleaner 30.

The channel formation member 70 has a shape of a circular arc in plan view. The channel formation member 70 is disposed inward of an inner circumferential face 64b of the cleaner element 64. An outer circumferential face 70a of the channel formation member 70 and the element inner circumferential face 64b are separated from each other (FIG. 2).

As is understandable from FIG. 2, the first inlet 60 and the second inlet 62 are opened independently from each other, with respect to an internal space of the air cleaner 30. The first inlet 60 and the second inlet 62 are located adjacently to each other. The first inlet 60 leading to the intake system air channel is located at an inner circumferential side of the air cleaner base 30a, and the second inlet 62 leading to the intake system air-fuel mixture channel is located at an outer circumferential side of the air cleaner base 30a.

The channel formation member 70 attached to the second inlet 62 extends in a circumferential direction along an outer circumferential portion of the air cleaner base 30a. In the channel formation member 70, the entrance opening 72a of the extension air-fuel mixture channel 72 is located in a vicinity of the exit opening 72b, that is, the second inlet 62.

The first inlet 60 leading to the intake system air channel has a periphery thereof surrounded by the channel formation member 70. The channel formation member 70 configures an inner circumferential wall face 70b (FIG. 2) that defines a blowback fuel diffusion prevention region 74 leading to the first inlet 60.

The cleaner element 64 has the shape of a circular ring as described above. The purified air filtered by the cleaner element 64 is stored in a space surrounded by the cleaner element 64. The space surrounded by the cleaner element 64 will be referred to as an “air cleaner clean space”. The first and second inlets 60 and 62 are opened to the air cleaner clean space.

The cleaner element 64 has a ceiling plate member 66 (FIG. 1) that defines a ceiling wall of the air cleaner 30. The ceiling plate member 66 which is located to face the air cleaner base 30a closes the blowback fuel diffusion prevention region 74. That is, the blowback fuel diffusion prevention region 74 is defined by the air cleaner base 30a, the inner circumferential wall face 70b (FIG. 2) of the channel formation member 70 and the ceiling plate member 66.

A part of the purified air which is purified by the cleaner element 64 enters the extension air-fuel mixture channel 72 through the entrance opening 72a of the channel formation member 70 (the extension air-fuel mixture channel 72), subsequently passes through the extension air-fuel mixture channel 72, and passes through the exit opening 72b and the second inlet 62 to enter the intake system air-fuel mixture channel.

A part of the air which is purified by the cleaner element 64 enters the blowback fuel diffusion prevention region 74 through a first clearance gap 80 (FIG. 2) between the entrance opening 72a and the exit opening 72b of the channel formation member 70 (the extension air-fuel mixture channel 72). Subsequently, the part of the purified air enters the intake system air channel through the first inlet 60. In other words, the blowback fuel diffusion prevention region 74 opens to the air cleaner clean space through the first clearance gap 80.

During an operation of the engine 100, blowback of the air-fuel mixture through the intake system air-fuel mixture channel enters the channel formation member 70. A fuel component and an oil component contained in the blowback air-fuel mixture adhere to a wall face of the relatively long channel formation member 70. Accordingly, contamination of the cleaner element 64 with the blowback air-fuel mixture can be prevented.

During an operation of the engine 100, the blowback air which flows back through the intake system air channel is prevented from diffusing by the inner circumferential wall face 70b of the channel formation member 70. That is, the blowback air is stored in the blowback fuel diffusion prevention region 74. Thereby, even if the air-fuel mixture and the oil component are included in the blowback air, contamination of the cleaner element 64 with this can be prevented.

The ceiling plate member 66 which forms the ceiling wall of the blowback fuel diffusion prevention region 74 may be of an integrated structure with the cleaner element 64, or may be configured by a different member from the cleaner element 64.

A shape of the channel formation member 70 at the time of seeing the channel formation member 70 in plan view is not limited to a circular shape. The shape may be an elliptical shape, or a polygonal shape. The term “polygonal shape” is not limited to the term geometrically used. The term means a shape having corners. The corners are preferably rounded. The channel formation member 70 may have a folded shape like a hairpin or a bent shape.

In the example in FIG. 2, air is introduced into the blowback fuel diffusion prevention region 74 through the first clearance gap 80 between one end and the other end of the channel formation member 70. In other words, the blowback fuel diffusion prevention region 74 opens to the air cleaner clean space through the first clearance gap 80. A size of the first clearance gap 80 can be arbitrarily set by changing the length and the shape of the channel formation member 70 as described above. An amount of the air which is introduced into the blowback fuel diffusion prevention region 74 may be adjusted by using a second clearance gap between the channel formation member 70 and the ceiling plate member 66. In other words, the blowback fuel diffusion prevention region 74 may be opened to the air cleaner clean space through the second clearance gap. The second clearance gap may be a clearance gap extending throughout an entire length in a lengthwise direction of the channel formation member 70, or may be a partial clearance gap.

The extension air-fuel mixture channel 72 of the channel formation member 70 most preferably has same effective sectional areas in respective portions in the lengthwise direction. The effective sectional areas of the respective portions, of course, may differ within an allowable range.

Referring to FIG. 2, the first inlet 60 leading to the intake system air channel is located at the inner circumferential side from the second inlet 62 leading to the intake system air-fuel mixture channel The channel formation member 70 is attached to the second inlet 62. When attention is paid to a portion at the second inlet 62 in the channel formation member 70, that is, a portion at the exit opening 72b in the channel formation member 70 (the extension air-fuel mixture channel 72), the portion at the exit opening 72b configures a reflection wall adjacent to the first inlet 60.

Thereby, the portion at the exit opening 72b in the channel formation member 70 forms the reflection wall to the blowback air flowing from the first inlet 60. The reflection wall can effectively prevent the fuel component contained in the blowback air flowing from the first inlet 60 from diffusing to the cleaner element 64 side. That is, the blowback air is reflected toward the blowback fuel diffusion prevention region 74 by the reflection wall.

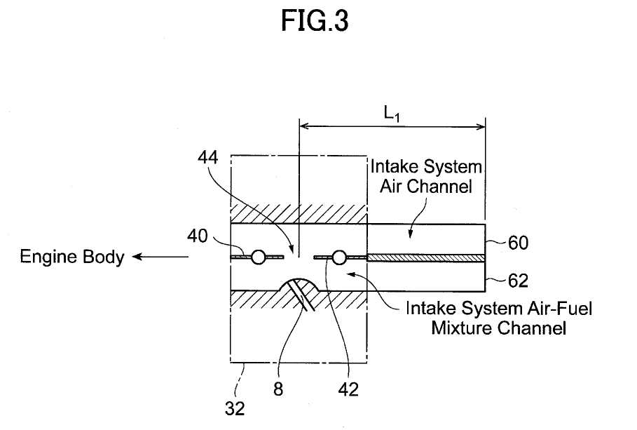

FIGS. 3 and 4 show diagrams schematically showing the intake system of the stratified scavenging two-stroke internal combustion engine 100. FIG. 3 shows the intake system in which the channel formation member 70 is removed from the air cleaner 30, as a comparative example. FIG. 4 shows the intake system of the embodiment in which the channel formation member 70 is attached to the air cleaner 30 to extend the intake system air-fuel mixture channel. Note that in FIG. 4, the extension air-fuel mixture channel 72 formed by the channel formation member 70 is illustrated rectilinearly.

Returning to FIG. 1, a channel length to the air cleaner 30 from the aforementioned window, that is, the opening portion 44 between the throttle valve 40 and the choke valve 42 is illustrated as “L1”. L1 is 17.5 mm in this embodiment.

In FIG. 4, a channel length of the extension air-fuel mixture channel 72 is illustrated as “L2”. The channel length L2 of the extension air-fuel mixture channel 72 described with reference to FIGS. 1 and 2 is 172.5 mm.

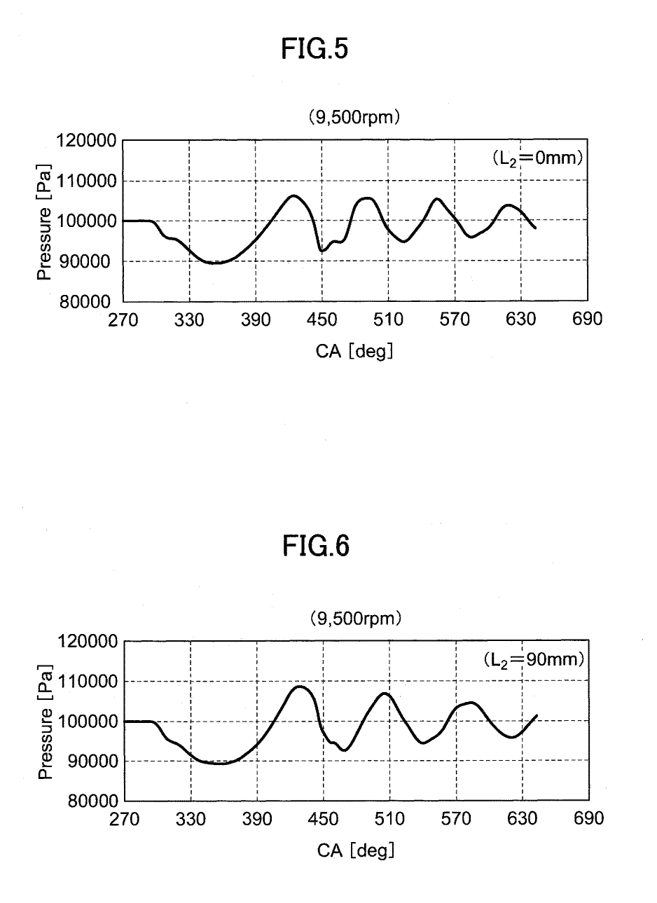

In the comparative example illustrated in FIG. 3, the channel length L2 is “zero”, because there is no extension air-fuel mixture channel 72 (L2=0). Relations between the different channel lengths L2 of the extension air-fuel mixture channel 72 and pressure fluctuations in a vicinity of the main nozzle 8 were verified. FIG. 5 to FIG. 11 show pressure fluctuations in the vicinity of the main nozzle 8 at a time of the engine speed of 9,500 rpm. FIG. 12 to FIG. 16 show pressure fluctuations in the vicinity of the main nozzle 8 at a time of the engine speed of 8,000 rpm. In the drawings, CA denotes a crank angle.

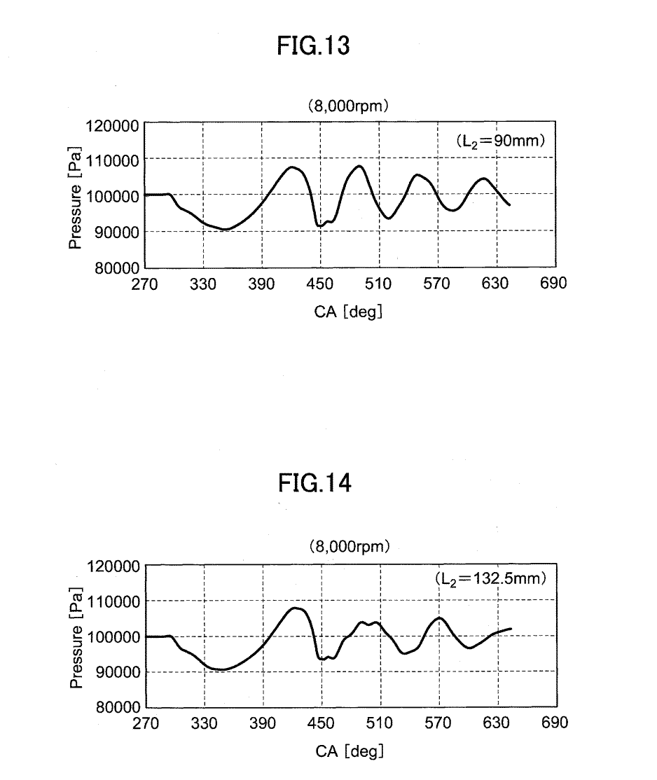

Seeing FIGS. 5 to 11 (the engine speed of 9,500 rpm) and FIGS. 12 to 16 (the engine speed of 8,000 rpm), no serious change is seen in amplitudes of the pressure fluctuations when the channel length L2 of the extension air-fuel mixture channel 72 is 0 mm (FIG. 5 and FIGS. 12) to 90 mm (FIG. 6 and FIG. 13). In this connection, the engine speeds of 9,500 rpm and 8,000 rpm are the numbers of revolutions at which the engine 100 operates at a high speed revolution.

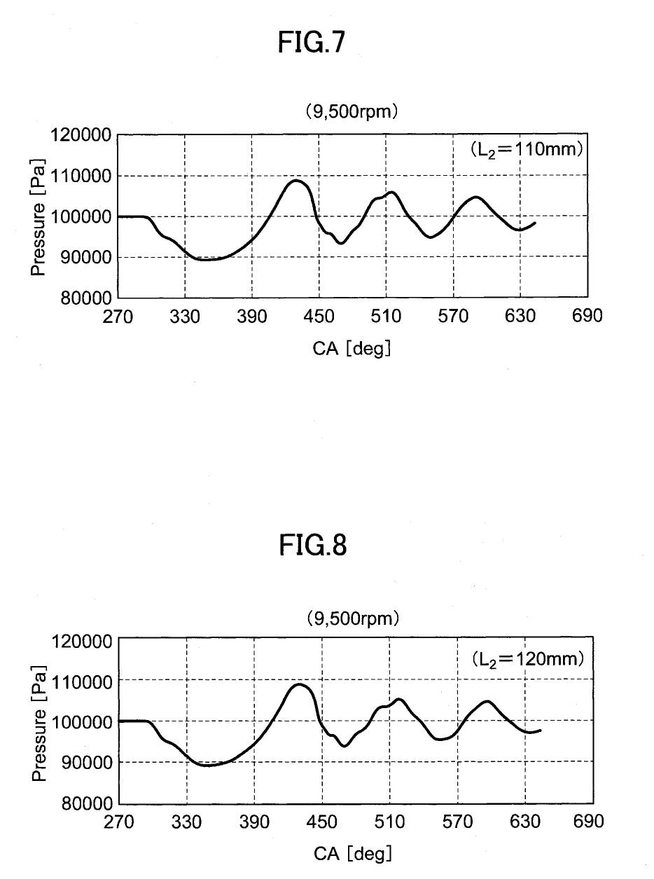

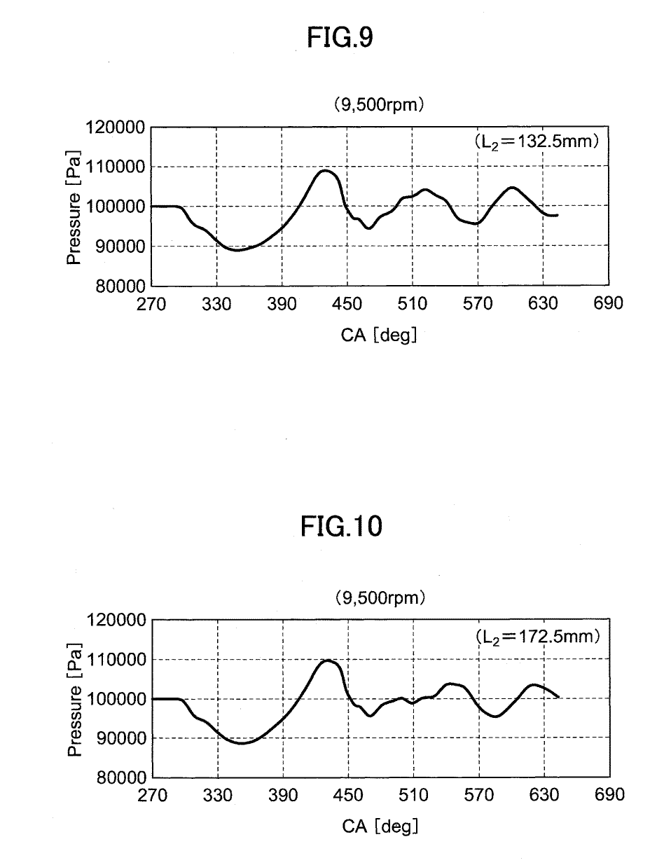

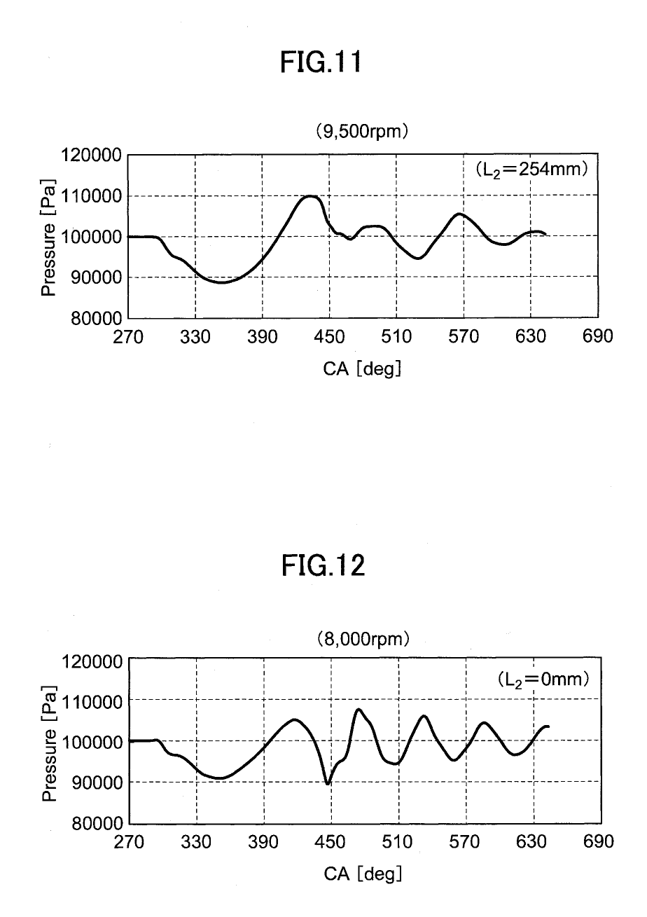

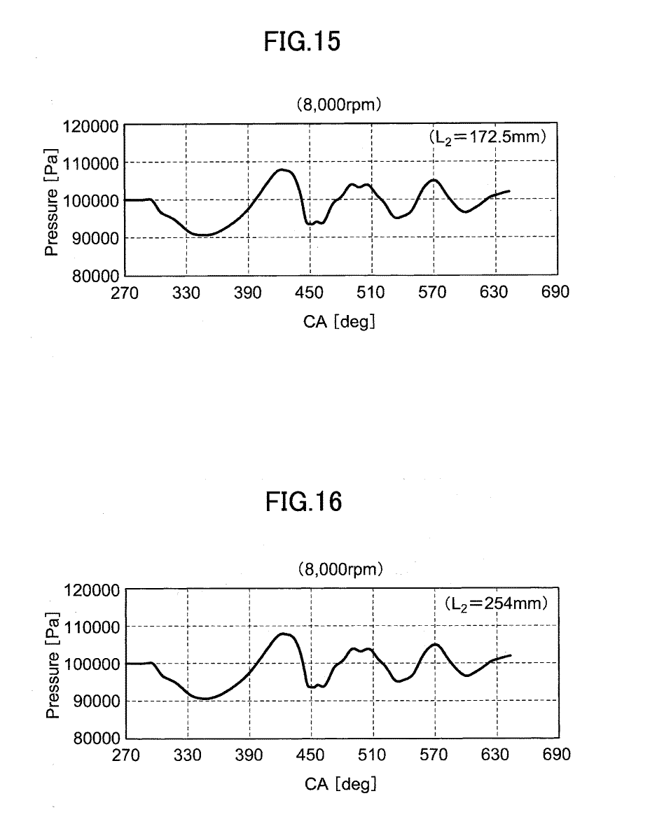

FIGS. 5 and 12 show pressure waves at a time of the extension channel length L2 satisfying “L2=0 mm” FIGS. 6 and 13 show pressure waves at a time of the extension channel length L2 satisfying “L2=90 mm” FIG. 7 shows a pressure wave at a time of the extension channel length L2 satisfying “L2=110 mm” FIG. 8 shows a pressure wave at a time of the extension channel length L2 satisfying “L2=120 mm” FIGS. 9 and 14 show pressure waves at a time of the extension channel length L2 satisfying “L2=132.5 mm” FIGS. 10 and 15 show pressure waves at a time of the extension channel length L2 satisfying “L2=172.5 mm”. FIGS. 11 and 16 show pressure waves at a time of the extension channel length L2 satisfying “L2=254 mm”.

Seeing a waveform in FIG. 7 (the extension channel length L2=110 mm), it is found that the amplitude of the pressure fluctuation is relatively smaller as compared with a waveform illustrated in FIG. 5 (L2=0 mm) When the extension channel length L2 becomes longer than 120 mm, decrease in the amplitude of the pressure fluctuation becomes notable (FIGS. 8 to 11, and FIGS. 14 to 16). The tendency can be considered to be such that if the extension channel length L2 is made longer, the amplitude of the pressure fluctuation also becomes smaller. However, a maximum length of the extension channel length L2 is actually defined by the size of the air cleaner 30. The maximum length of the extension channel length L2 is actually 254 mm.

As described above, the first inlet 60 and the second inlet 62 are located on the air cleaner base 30a (FIG. 1). The channel formation member 70 is attached to the second inlet 62, and the extension air-fuel mixture channel 72 is formed by the channel formation member 70. The extension air-fuel mixture channel 72 substantially extends the air-fuel mixture channel of the engine intake system.

The intake system air channel and the intake system air-fuel mixture channel communicate with each other by the window, that is, the above described opening portion 44 in the partition wall of the carburetor 32. In other words, even when the throttle valve 40 and the choke valve 42 are in the fully opened states, the intake system air channel and the intake system air-fuel mixture channel communicate with each other through the opening portion 44. A distance between the opening portion 44 and the first inlet 60 of the air cleaner 30 is referred to as a “first distance”, and a distance between the opening portion 44 and the second inlet 62 of the air cleaner 30 is referred to as a “second distance”.

As is understandable from FIG. 4, the first distance and the second distance are substantially equal to each other (the above described “L1”). Accordingly, a channel length of the air-fuel mixture channel from the opening portion 44 through the second inlet 62 to the extension air-fuel mixture channel 72 is longer than the air channel length L1 from the opening portion 44 to the first inlet 60. A difference thereof is the channel length L2 of the extension air-fuel mixture channel 72.

Accordingly, a relative difference in length between the channel length of the air channel extending from the opening portion 44 to the upstream side of the opening portion 44, and the channel length of the air-fuel mixture channel (including the extension air-fuel mixture channel) extending from the opening portion 44 to the upstream side of the opening portion 44 can be said as the channel length L2 of the extension air-fuel mixture channel 72.

According to the data illustrated in FIGS. 5 to 11 and FIGS. 12 to 16 described above, there is no change up to the extension channel length L2 of 90 mm, but when L2 is 110 mm, a change appears in the amplitude of the pressure fluctuation. Accordingly, it can be said that when the extension channel length L2 is longer than 90 mm, the amplitude of the pressure fluctuation in the vicinity of the main nozzle 8 tends to be small. It is found that when the extension channel length L2 becomes 110 mm or more, the amplitude of the pressure fluctuation becomes small. Further, it is found that when the extension channel length L2 becomes 120 mm or more, decrease in the pressure fluctuation in the vicinity of the main nozzle 8 becomes notable. The maximum value of the extension channel length L2 is actually approximately 250 mm.

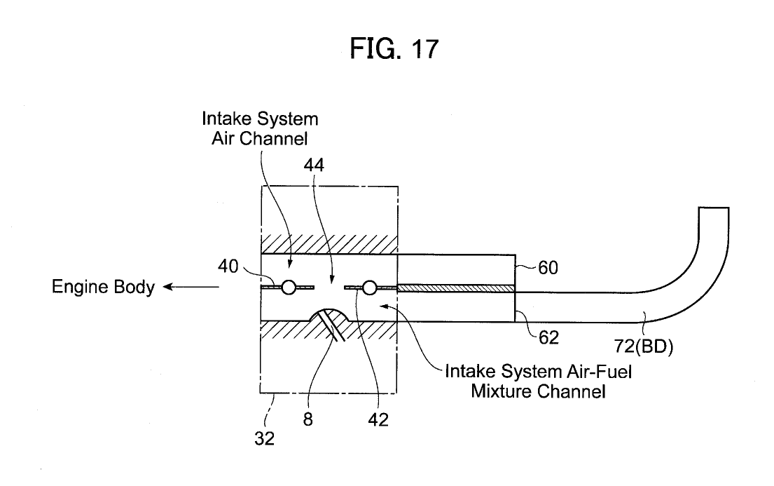

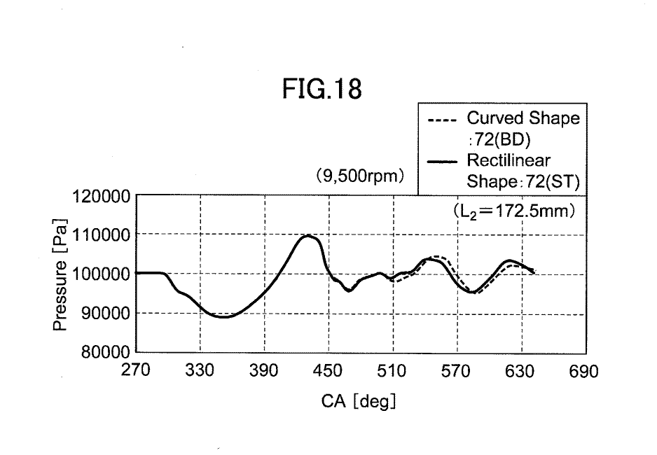

Next, a difference between a case where the channel shape of the extension air-fuel mixture channel 72 was made rectilinear and a case where the channel shape of the extension air-fuel mixture channel 72 was made a curved shape was verified. FIG. 17 shows the extension air-fuel mixture channel 72 (BD) in a curved shape. The extension air-fuel mixture channel (ST) in the rectilinear shape is as illustrated in FIG. 4 described above. FIG. 18 shows the pressure fluctuation in the vicinity of the main nozzle 8 at the time of the channel length L2 of the extension air-fuel mixture channel 72 being 172.5 mm and the engine speed being 9,500 rpm. The extension air-fuel mixture channel 72 (ST) in the rectilinear shape is shown by the solid line, and the extension air-fuel mixture channel 72 (BD) in the curved shape is shown by the broken line. From FIG. 18, it is found that the pressure fluctuation in the vicinity of the main nozzle 8 is not influenced by the shape of the extension air-fuel mixture channel 72.

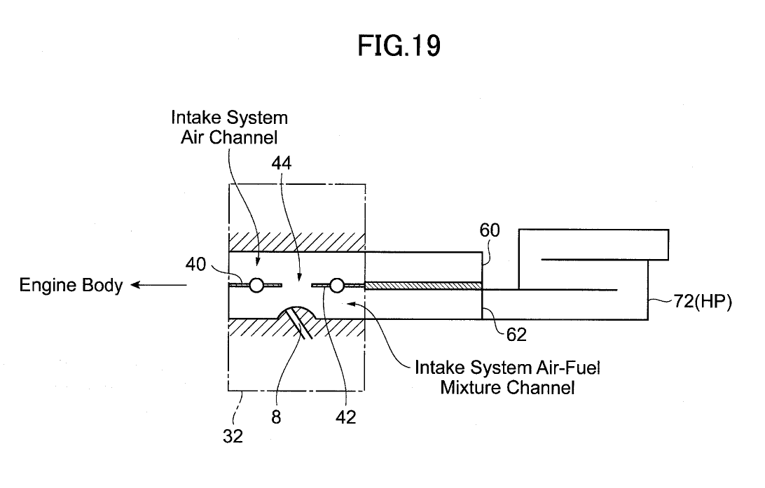

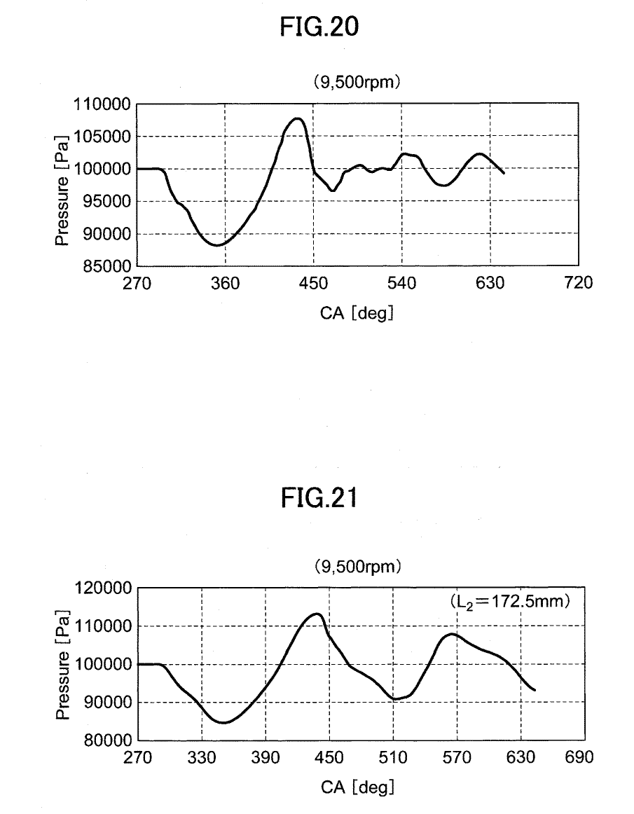

FIG. 19 shows an example in which the extension air-fuel mixture channel 72 is bent into a hairpin shape. The extension air-fuel mixture channel 72 (HP) illustrated in FIG. 19 has hairpin-shaped bent portions at two spots. The channel length L2 of the hairpin-shaped extension air-fuel mixture channel 72 (HP) is 172.5 mm. FIG. 20 shows a pressure fluctuation in the vicinity of the main nozzle 8 at the time of the engine speed of 9,500 rpm in the extension air-fuel mixture channel 72 (HP) which is bent into the hairpin shape illustrated in FIG. 19. It is found that the pressure fluctuation in the vicinity of the main nozzle 8 is not influenced by the shape of the extension air-fuel mixture channel 72 as in the extension air-fuel mixture channel 72 (BD) in the curved shape.

FIG. 21 shows a pressure fluctuation in the vicinity of the main nozzle 8 in a comparative example. The comparative example is a stratified scavenging two-stroke internal combustion engine in a state where an intake system air channel and an intake system air-fuel mixture channel are separated. The example is typically the engine including the first type carburetor disclosed in FIG. 3 of U.S. Pat. No. 7,494,113 B2 described above. FIG. 21 shows the pressure fluctuation in the vicinity of the main nozzle 8 at the time of the intake system air-fuel mixture channel being extended with the extension air-fuel mixture channel 72 in this engine. The channel length L2 of the extension air-fuel mixture channel 72 is 172.5 mm, and the engine speed is 9,500 rpm.

As is immediately understandable when the waveform in FIG. 21 and the waveform in FIG. 10 are compared, the intake system including the opening portion 44 has a much smaller amplitude of the pressure fluctuation. Further, from comparison of FIG. 21 and FIG. 10, it is obvious that in the engine of the embodiment in which the intake system air channel and the intake system air-fuel mixture channel communicate with each other via the opening portion 44, the pressure fluctuation of the intake system air channel, and the pressure fluctuation of the air-fuel mixture channel interfere with each other in the opening portion 44, and as a result, the amplitude of the pressure fluctuation in the vicinity of the main nozzle 8 is decreased.

When based on a viewpoint of interference of the two pressure fluctuations, the present invention proposes an intake method for making contact of air flow in the air channel 50, 54 and air-fuel mixture in the air-fuel mixture channel 52, 56 in the intake system 6 through the opening portion 44, and thereby decreasing the pressure fluctuation in the vicinity of the nozzle 8.

Although the example of extending the intake system air-fuel mixture channel is described thus far as the embodiment of the present invention, the present invention is not limited to this. The present invention also can be applied to an embodiment of extending the intake system air channel, instead of extending the intake system air-fuel mixture channel.

### REFERENCE NUMERALS LIST

100 Stratified scavenging engine
2 Engine body
6 Intake system
8 Main nozzle
12 Piston
14 Combustion chamber
18 Air-fuel mixture port
20 Crank chamber
22 Scavenging channel
24 Scavenging port
26 Air port
28 Piston groove
30 Air cleaner
32 Carburetor
44 Opening portion between intake system air channel and intake system air-fuel mixture channel
50, 54 Air channel in intake system
52, 56 Air-fuel mixture channel in intake system
60 First inlet (leading to intake system air channel)
62 Second inlet (leading to intake system air-fuel mixture channel)
70 Channel formation member
72 Extension air-fuel mixture channel
L2 Extension channel length

What is claimed is:

1. A stratified scavenging two-stroke internal combustion engine configured to feed a combustion chamber with first leading air and subsequently with air-fuel mixture from a crank chamber in a scavenging stroke of the engine, comprising:
an intake device having an air channel and an air-fuel mixture channel, the air channel feeding the leading air to an engine body, and the air-fuel mixture channel generating the air-fuel mixture and feeding the air-fuel mixture to the crank chamber of the engine body; and
an opening portion provided in the intake device to make communication between the air channel and the air-fuel mixture channel,
wherein one of the air channel and the air-fuel mixture channel is longer by 110 mm or more than the other of the air channel and the air-fuel mixture channel when viewed in an upstream side of the opening portion.

2. The stratified scavenging two-stroke internal combustion engine of claim 1, wherein said one of the air channel and the air-fuel mixture channel is longer by 120 mm or more than the other of the air channel and the air-fuel mixture channel when viewed in an upstream side of the opening portion.

3. The stratified scavenging two-stroke internal combustion engine of claim 1, wherein said one of the air channel and the air-fuel mixture channel is longer by a value not exceeding 254 mm than the other of the air channel and the air-fuel mixture channel when viewed in an upstream side of the opening portion.

4. The stratified scavenging two-stroke internal combustion engine of claim 2, wherein said one, of the air channel and the air-fuel mixture channel is longer by a value not exceeding 254 mm than the other of the air channel and the air-fuel mixture channel when viewed in an upstream side of the opening portion.

5. The stratified scavenging two-stroke internal combustion engine of claim 1,
the stratified scavenging two-stroke internal combustion engine comprising a carburetor,
wherein the carburetor has a main nozzle for feeding fuel to the air-fuel mixture channel, and
the opening portion is located in a vicinity of the main nozzle.

6. The stratified scavenging two-stroke internal combustion engine of claim 2,
the stratified scavenging two-stroke internal combustion engine comprising a carburetor,
wherein the carburetor has a main nozzle for feeding fuel to the air-fuel mixture channel, and
the opening portion is located in a vicinity of the main nozzle.

7. The stratified scavenging two-stroke internal combustion engine of claim 3,
the stratified scavenging two-stroke internal combustion engine comprising a carburetor,
wherein the carburetor has a main nozzle for feeding fuel to the air-fuel mixture channel, and
the opening portion is located in a vicinity of the main nozzle.

8. The stratified scavenging two-stroke internal combustion engine of claim 4,
the stratified scavenging two-stroke internal combustion engine comprising a carburetor,
wherein the carburetor has a main nozzle for feeding fuel to the air-fuel mixture channel, and
the opening portion is located in a vicinity of the main nozzle.

9. An air cleaner for a stratified scavenging two-stroke internal combustion engine, the engine having
an engine body configured to feed a combustion chamber with first leading air and subsequently with air-fuel mixture from a crank chamber in a scavenging stroke of the engine,
an air channel for feeding air for the leading air to the engine body,
an air-fuel mixture channel for feeding the air-fuel mixture to a crank chamber of the engine body,
a carburetor including a main nozzle for feeding fuel to the air-fuel mixture channel, and
an opening portion making communication between the air channel and the air-fuel mixture channel,
the air cleaner comprising:
a cleaner element for filtering outside air;
a first inlet for feeding purified air filtered through the cleaner element to the air channel;
a second inlet for feeding the purified air filtered through the cleaner element to the air-fuel mixture channel; and
a channel formation member attached to one of the first inlet and the second inlet to extend said one of the first inlet and the second inlet,
wherein a channel length of an extension channel formed by the channel formation member is 110 mm or more.

10. The air cleaner for the stratified scavenging two-stroke internal combustion engine of claim 9, wherein the channel length of the extension channel is 120 mm or more.

11. The air cleaner for the stratified scavenging two-stroke internal combustion engine of claim 9, wherein the opening portion is located in a vicinity of the main nozzle.

12. The air cleaner for the stratified scavenging two-stroke internal combustion engine of claim 10, wherein the opening portion is located in a vicinity of the main nozzle.

13. The air cleaner for the stratified scavenging two-stroke internal combustion engine of claim 9, wherein the opening portion is located between the carburetor and the engine body.

14. The air cleaner for the stratified scavenging two-stroke internal combustion engine of claim 10, wherein the opening portion is located between the carburetor and the engine body.

15. An intake method of a stratified scavenging two-stroke internal combustion engine configured to feed a combustion chamber with first leading air and subsequently with air-fuel mixture from a crank chamber in a scavenging stroke of the engine,
wherein the engine has
an air channel for feeding purified air filtered through an cleaner element to an engine body,
an air-fuel mixture channel for feeding the purified air to a carburetor to generate air-fuel mixture with fuel from a main nozzle in the carburetor, and feeds the air-fuel mixture to the crank chamber, and
an opening portion making communication between the air channel and the air-fuel mixture channel, the opening portion being located in a vicinity of the main nozzle,
wherein one of the air channel and the air-fuel mixture channel is longer than the other of the air channel and the air-fuel mixture channel when viewed in an upstream side of the opening portion, and
wherein the intake method comprises
a first step for generating air flow in in the air channel,
a second step for generating air-fuel mixture flow in the air channel,
a third step for making contact of the air flow and the air-fuel mixture flow through the opening portion to make pressure fluctuations of these flows to interfere with each other and thereby decrease a pressure fluctuation in a vicinity of the main nozzle.

16. The intake method of the stratified scavenging two-stroke internal combustion engine of claim 15,
wherein the third step is performed in an operation state where the engine rotates at a high speed.
